(19) United States
(12) Patent Application Publication
(10) Pub. No.: US 2006/0176999 A1
(43) Pub. Date: Aug. 10, 2006

(54) X-RAY IMAGING DEVICE ADAPTED FOR COMMUNICATING DATA IN REAL TIME VIA NETWORK INTERFACE

(75) Inventors: Cesar Humberto Proano, Milpitas, CA (US); George Zentai, Mountain View, CA (US); Christopher Webb, Los Altos, CA (US)

Correspondence Address: VEDDER PRICE KAUFMAN & KAMMHOLZ, 222 N. LASALLE STREET, CHICAGO, IL, 60601, US

(73) Assignee: VARIAN MEDICAL SYSTEMS TECHNOLOGIES, INC., Palo Alto, CA (US)

(21) Appl. No.: 10/906,180

(22) Filed: Feb. 7, 2005

(51) Int. Cl. H05G 1/08

(52) U.S. Cl. 378/91

(57) ABSTRACT

An X-ray imaging device adapted for communicating image data in real time via a network interface. Image data signals from an X-ray imaging detector assembly resulting from conversion of impinging X-ray photons corresponding to a subject image are, in turn, converted to one or more corresponding network data signals, such as Gigabit Ethernet signals.

### BACKGROUND OF THE INVENTION

The present invention relates to x-ray imaging devices, and in particular, to x-ray imaging devices adapted for communicating image data via a network interface.

### DESCRIPTION OF THE RELATED ART

Referring to FIG. 1, a conventional medical imaging system 10 includes a receptor 12 and a processor 14 for collecting subject image data and communicating it to a computer 16 for viewing, processing or storage. As is well known in the art, the impinging x-ray photons 11 corresponding to the subject image are converted by the receptor 12 to image data signals which are conveyed via an interface 13 to the processor 14. This processor 14 is typically controlled by software for processing uncorrected image data from the receptor 12 so as to provide corrected or otherwise processed image data to the computer 16 via another interface 15. (The interface 13 also generally provides control signals, such as synchronization signals, as well as power to the receptor 12.)

### SUMMARY OF THE INVENTION

In accordance with the presently claimed invention, an X-ray imaging device is adapted for communicating image data in real time via a network interface. Image data signals from an X-ray imaging detector assembly resulting from conversion of impinging X-ray photons corresponding to a subject image are, in turn, converted to one or more corresponding network data signals, such as Gigabit Ethernet signals.

In accordance with one embodiment of the presently claimed invention, an X-ray imaging device adapted for communicating image data in real time via a network interface includes an X-ray imaging detector assembly and interface circuitry. The X-ray imaging detector assembly is responsive to a plurality of impinging X-ray photons corresponding to a subject image by providing a plurality of image data signals representing the subject image. The interface circuitry is coupled to the X-ray imaging detector assembly and responsive to the plurality of image data signals by providing one or more network data signals corresponding to the plurality of image data signals.

Oln accordance with another embodiment of the presently claimed invention, an X-ray imaging device adapted for communicating image data in real time via a network interface includes a layer of scintillation material, detector circuitry and interface circuitry. The layer of scintillation material is responsive to a plurality of impinging X-ray photons corresponding to a subject image by providing a corresponding plurality of visible light photons. The detector circuitry is disposed at least in part substantially proximate to the layer of scintillation material and responsive to the plurality of visible light photons by providing a plurality of image data signals representing the subject image. The interface circuitry is coupled to the detector circuitry and responsive to the plurality of image data signals by providing one or more network data signals corresponding to the plurality of image data signals.

In accordance with another embodiment of the presently claimed invention, an X-ray imaging device adapted for communicating image data in real time via a network interface includes X-ray imaging detector means and interface means. The X-ray imaging detector means is for converting a plurality of impinging X-ray photons corresponding to a subject image to a plurality of image data signals representing the subject image. The interface means is for converting the plurality of image data signals to one or more network data signals corresponding to the plurality of image data signals.

In accordance with another embodiment of the presently claimed invention, an X-ray imaging device adapted for communicating image data in real time via a network interface includes scintillator means, detector means and interface means. The scintillator means is for converting a plurality of impinging X-ray photons corresponding to a subject image to a corresponding plurality of visible light photons. The detector means is for converting the plurality of visible light photons to a plurality of image data signals representing the subject image. The interface means is for converting the plurality of image data signals to one or more network data signals corresponding to the plurality of image data signals.

### BRIEF DESCRIPTION OF THE DRAWINGS

FIG. 1 is a functional block diagram of a conventional x-ray imaging system.

FIG. 2 is a functional block diagram depicting the use of an x-ray imaging device in accordance with one embodiment of the presently claimed invention communicating with a computer via a network.

FIG. 3 is a functional block diagram of an x-ray imaging device in accordance with one embodiment of the presently claimed invention.

FIG. 4 is a functional block diagram of the interface circuitry of FIG. 3.

FIG. 5 is a functional block diagram depicting a network communication capability of an x-ray imaging device in accordance with one embodiment of the presently claimed invention.

### DETAILED DESCRIPTION OF THE INVENTION

The following detailed description is of example embodiments of the presently claimed invention with references to the accompanying drawings. Such description is intended to be illustrative and not limiting with respect to the scope of the present invention. Such embodiments are described in sufficient detail to enable one of ordinary skill in the art to practice the subject invention, and it will be understood that other embodiments may be practiced with some variations without departing from the spirit or scope of the subject invention.

Throughout the present disclosure, absent a clear indication to the contrary from the context, it will be understood that individual circuit elements as described may be singular or plural in number. For example, the terms “circuit” and “circuitry” may include either a single component or a plurality of components, which are either active and/or passive and are connected or otherwise coupled together (e.g., as one or more integrated circuit chips) to provide the described function. Additionally, the term “signal” may refer to one or more currents, one or more voltages, or a data signal. Within the drawings, like or related elements will have like or related alpha, numeric or alphanumeric designators. Further, while the present invention has been discussed in the context of implementations using discrete electronic circuitry (preferably in the form of one or more integrated circuit chips), the functions of any part of such circuitry may alternatively be implemented using one or more appropriately programmed processors, depending upon the signal frequencies or data rates to be processed.

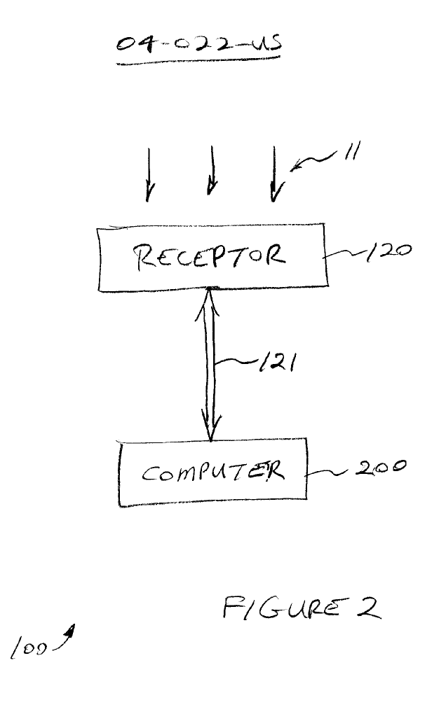

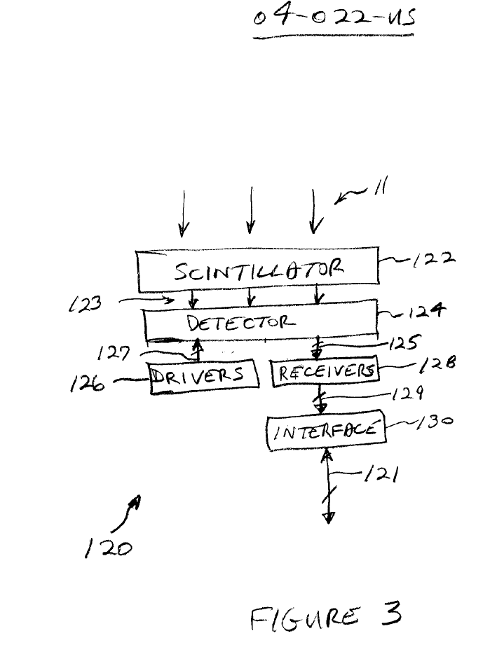

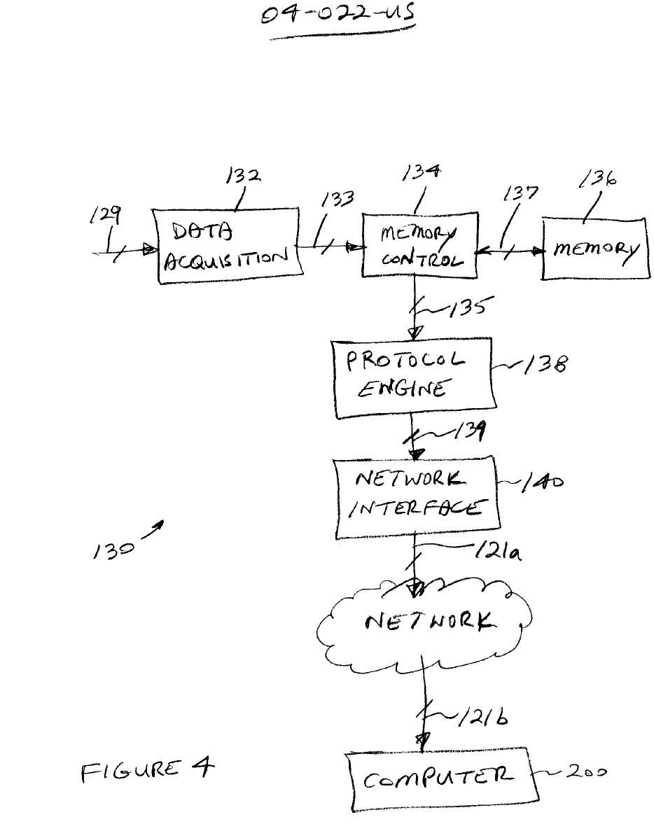

Referring to FIG. 2, in accordance with one embodiment of the presently claimed invention, a receptor 120 converts the impinging x-ray photons 11 to network data signals which are communicated via a network interface 121 to a computer 200. Referring to FIG. 3, a receptor 120 in accordance with one embodiment of the presently claimed invention includes a scintillator 122, a detector array 124, driver circuitry 126, receiver circuitry 128 and interface circuitry 130, all interconnected substantially as shown. In accordance with well known principles, the impinging x-ray photons 11 are absorbed by the scintillator 122, e.g., a layer of scintillation material such as cesium iodide, and converted to visible light photons 123. These visible light photons 123 are received by the detector array 124 and converted to multiple pixel data signals in the form of electrical charges. The driver circuitry 126 provides appropriate addressing and control signals 127 to the detector array 124, in response to which electrical pixel data signals 125 (representing a two dimensional array of image data) are provided, e.g., one line at a time, to the receiver circuitry 128. Such a combination and operation of a scintillator 122, detector array 124, driver circuitry 126 and receiver circuitry 128 are well known in the art. (A more detailed discussion of such elements can be found in U.S. Pat. No. 5,970115, the disclosure of which is incorporated herein by reference.) The image data signals 129 produced by the receiver circuitry 128 are provided to the interface circuitry 130 for conversion into the appropriate form of network data signals for communication via the network signal interface 121.

It will be readily appreciated by one of ordinary skill in the art that, as an alternative, the detector array 124 can also be of the type that does not require a scintillator 122. As is well known, such a detector array is responsive to the impinging x-ray photons 11 without requiring that the photons 11 first be converted to visible light photons 123. Instead, the impinging x-ray photons 11 are converted to electrical charges to form the pixel data signals. Such charges are then accessed by the driver circuitry 126 which provides appropriate addressing and control signals 127 to the detector array 124, in response to which electrical pixel data signals 125 are provided, e.g., one line at a time, to the receiver circuitry 128.

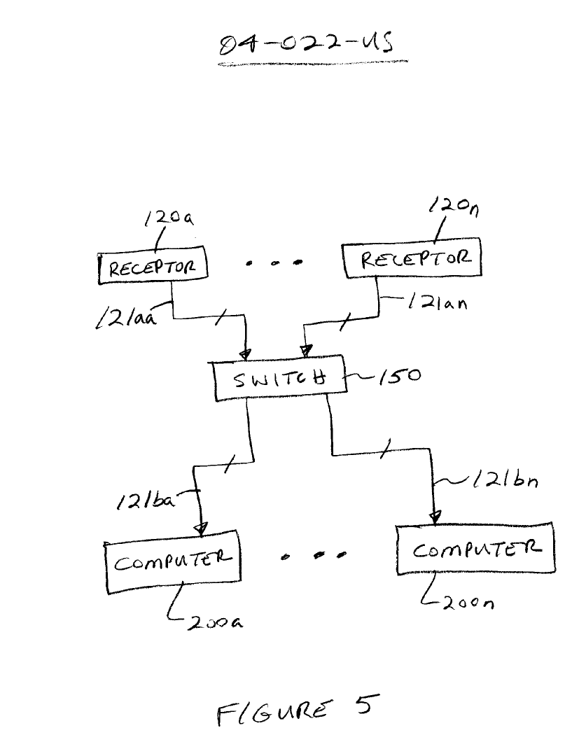

Referring to FIG. 4, one example of the interface circuit 130 includes data acquisition circuitry 132, memory control circuitry 134, memory circuitry 136, protocol engine circuitry 138 and network interface circuitry 140, all interconnected substantially as shown. The incoming image data signals 129 from the receiver circuitry 128 (FIG. 3) are received by the data acquisition circuitry 132. The acquired data signals 133, under control of the memory control circuitry 134, can be stored in the memory circuitry 136 or provided directly to the protocol engine circuitry 138. The image data signals 135, e.g., in the form of either the acquired data signals 133 or the stored image data signals 137, are provided to the protocol engine circuitry 138 for conversion to the outgoing signals 139 having the desired signal protocol associated therewith. In accordance with a preferred embodiment of the presently claimed invention, the desired protocol is Ethernet, and in particular, Gigabit Ethernet. Hence, it is within the protocol engine circuitry 138 that the network communication protocol is established for the outgoing data signals 139. (One example of such a system for acquiring and converting image data for communication via Gigabit Ethernet is the iPort™ PT1000-CL internet protocol engine produced by Pleora Technologies, Inc., of Ontario, Canada, the details of which can be found at their web site www.pleora.com. However, it should be understood that other internet protocol engines can be used to perform this function as well.)

These outgoing data signals 139 are further converted by the network interface circuitry 140 to the appropriate physical signal interface for transmission as the final outgoing data signals 121a. For example in the case of Gigabit Ethernet, the network interface 140 could be one of at least two forms: electrical signal interface circuitry for providing the outgoing data signals 121 a as electrical signals, such as 1000BASE-T signals, or fiber optic signals for communication via fiber optic cable.

Following their conveyance via the network, the image data signals 121b can then be received by the computer 200 in conformance with the network interface standard and processed, e.g., for viewing the corresponding image, or stored as desired.

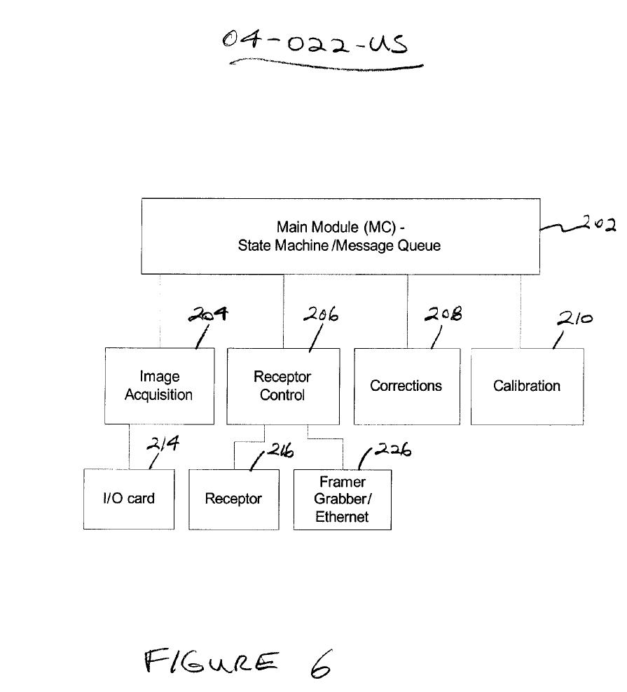

Referring to FIG. 5, an advantage of an x-ray imaging device adapted for communicating end data in real time via a network interface in accordance with the presently claimed invention is the ability to scale its connectivity. For example, such use of a standardized network communication interface allows multiple receptors 120a . . . , 120n to be connected to a conventional network switch 150 such that their respective image data 121aa . . . , 121an are available to multiple users. Multiple computers 200a . . . , 200n can be connected to the switch 150 to receive the switched data signals 121ba . . . , 121bn. This allows any one of the computers 200a, . . . , 200n to select any one of the sets of image data 121aa . . . , 121an. Each computer could be used to access a different set of image data from a different receptor, or one set of image data can be accessed by multiple computers. In the latter case, one computer could be used to view the accessed data, while a second computer could be used to process the accessed data, and a third computer could be used for storing or archiving the accessed data.

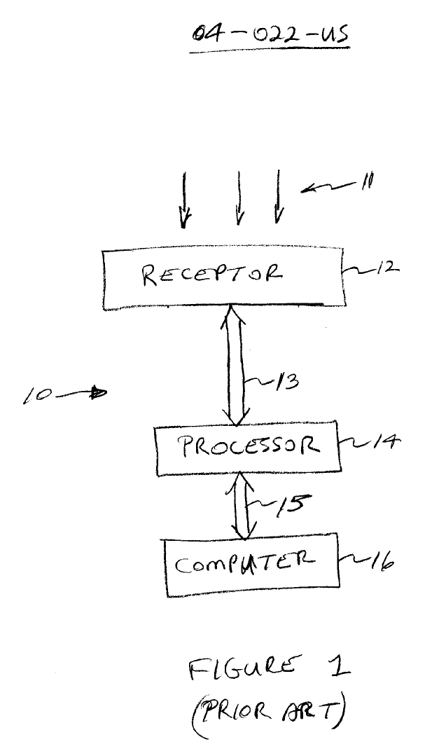

As discussed above, the network interface 140 (FIG. 4) is conventional. Accordingly, the circuitry for implementing this is preferably a conventional network interface card installed within the computer 200. Command processing associated with the system, performed by an external processor 14 in a conventional system 10 (FIG. 1) is now performed by software residing within the computer 200 (FIG. 4).

Referring to FIG. 6, this software is preferably implemented in a modular form for flexibility of design, operation and verification. In a preferred embodiment, a main module 202 performs virtually no functions itself but manages and controls four primary software modules, e.g., in the form of dynamic link libraries (DLLs): image acquisition 204, receptor control 206, corrections 208 and calibration 210. These modules 204, 206, 208, 210 are preferably independent of any actual devices for which they are responsible or with which they interact. During normal operation, the main module 202 will load the necessary files from these modules 204, 206, 208, 210 and obtain the necessary function addresses of the exported functions.

The image acquisition module 204 manages commands for controlling image acquisition. It makes calls to the receptor control module 206 and manages a dependent control module 214 for the input/output (I/O) card, i.e., the network interface 140. This I/O card module 214 provides the interface between the processing software and the physical network, e.g., via an input/output device such as a universal series bus (USB) device.

The receptor control module 206 manages receptor configuration data, as well as exporting video commands and providing a video interface. This module 206 controls a receptor module 216 which provides the data interface for the receptor 120 (FIG. 2). This module 206 also controls a frame grabber/Ethernet module 226 which provides a command interface to the receptor 120.

The corrections module 208 controls any necessary corrections for offset, gain and image defects (e.g., defective pixels).

The calibration module 210 provides for any necessary offsets for parameters such as pixel signal gains.

Various other modifications and alternations in the structure and method of operation of this invention will be apparent to those skilled in the art without departing from the scope and the spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. An apparatus including an X-ray imaging device adapted for communicating image data in real time via a network interface, comprising:
an X-ray imaging detector assembly responsive to a plurality of impinging X-ray photons corresponding to a subject image by providing a plurality of image data signals representing said subject image; and
interface circuitry coupled to said X-ray imaging detector assembly and responsive to said plurality of image data signals by providing one or more network data signals corresponding to said plurality of image data signals.

2. The apparatus of claim 1, wherein said X-ray imaging detector assembly comprises:
a detector array responsive to said plurality of impinging X-ray photons by providing a plurality of pixel data signals representing said subject image; and
pixel data readout circuitry coupled to said photosensitive detector array and responsive to said plurality of pixel data signals by providing said plurality of image data signals.

3. The apparatus of claim 1, wherein said interface circuitry comprises:
protocol engine circuitry responsive to said plurality of image data signals by providing one or more intermediate data signals having at least a network layer protocol associated therewith; and
network interface circuitry coupled to said protocol engine circuitry and responsive to said one or more intermediate data signals by providing said one or more network data signals having data link and physical layer protocols associated therewith.

4. The apparatus of claim 3, wherein said data link protocol comprises an Ethernet protocol.

5. The apparatus of claim 4, wherein said Ethernet protocol comprises a Gigabit Ethernet protocol.

6. The apparatus of claim 3, wherein said physical layer protocol comprises an electrical signal interface protocol.

7. The apparatus of claim 3, wherein said physical layer protocol comprises a fiber optic signal interface protocol.

8. The apparatus of claim 1, wherein said one or more network data signals comprises one or more Ethernet signals.

9. The apparatus of claim 8, wherein said one or more Ethernet signals comprises one or more Gigabit Ethernet signals.

10. The apparatus of claim 1, wherein said one or more network data signals comprises one or more electrical data signals.

11. The apparatus of claim 1, wherein said one or more network data signals comprises one or more fiber optic data signals.

12. An apparatus including an X-ray imaging device adapted for communicating image data in real time via a network interface, comprising:
a layer of scintillation material responsive to a plurality of impinging X-ray photons corresponding to a subject image by providing a corresponding plurality of visible light photons;
detector circuitry disposed at least in part substantially proximate to said layer of scintillation material and responsive to said plurality of visible light photons by providing a plurality of image data signals representing said subject image; and
interface circuitry coupled to said detector circuitry and responsive to said plurality of image data signals by providing one or more network data signals corresponding to said plurality of image data signals.

13. The apparatus of claim 12, wherein said detector circuitry comprises:
a photosensitive detector array disposed at least in part substantially proximate to said layer of scintillation material and responsive to said plurality of visible light photons by providing a plurality of pixel data signals representing said subject image; and
pixel data readout circuitry coupled to said photosensitive detector array and responsive to said plurality of pixel data signals by providing said plurality of image data signals.

14. The apparatus of claim 12, wherein said interface circuitry comprises:
protocol engine circuitry responsive to said plurality of image data signals by providing one or more intermediate data signals having at least a network layer protocol associated therewith; and
network interface circuitry coupled to said protocol engine circuitry and responsive to said one or more intermediate data signals by providing said one or more network data signals having data link and physical layer protocols associated therewith.

15. The apparatus of claim 14, wherein said data link protocol comprises an Ethernet protocol.

16. The apparatus of claim 15, wherein said Ethernet protocol comprises a Gigabit Ethernet protocol.

17. The apparatus of claim 14, wherein said physical layer protocol comprises an electrical signal interface protocol.

18. The apparatus of claim 14, wherein said physical layer protocol comprises a fiber optic signal interface protocol.

19. The apparatus of claim 12, wherein said one or more network data signals comprises one or more Ethernet signals.

20. The apparatus of claim 19, wherein said one or more Ethernet signals comprises one or more Gigabit Ethernet signals.

21. The apparatus of claim 12, wherein said one or more network data signals comprises one or more electrical data signals.

22. The apparatus of claim 12, wherein said one or more network data signals comprises one or more fiber optic data signals.

23. An apparatus including an X-ray imaging device adapted for communicating image data in real time via a network interface, comprising:
X-ray imaging detector means for converting a plurality of impinging X-ray photons corresponding to a subject image to a plurality of image data signals representing said subject image; and
interface means for converting said plurality of image data signals to one or more network data signals corresponding to said plurality of image data signals.

24. An apparatus including an X-ray imaging device adapted for communicating image data in real time via a network interface, comprising:
scintillator means for converting a plurality of impinging X-ray photons corresponding to a subject image to a corresponding plurality of visible light photons;
detector means for converting said plurality of visible light photons to a plurality of image data signals representing said subject image; and
interface means for converting said plurality of image data signals to one or more network data signals corresponding to said plurality of image data signals.
